(19) United States
(12) Patent Application Publication
(10) Pub. No.: US 2004/0128478 A1
(43) Pub. Date: Jul. 1, 2004

(54) Method for identifying a correct command entry address when using command words of different length

(76) Inventors: Heimo Hartlieb, Graz (AT); Holger Sedlak, Egmating (DE)

Correspondence Address: LERNER AND GREENBERG, PA, P O BOX 2480, HOLLYWOOD, FL, 33022-2480, US

(21) Appl. No.: 10/694,591

(22) Filed: Oct. 27, 2003

Related U.S. Application Data
(63) Continuation of application No. PCT/DE02/01442, filed on Apr. 18, 2002.

(30) Foreign Application Priority Data
Apr. 26, 2001 (DE) 101 20 522.8

(51) Int. Cl. G06F 9/30

(52) U.S. Cl. 712/209; 712/242

(57) ABSTRACT

A method is provided for distinguishing a correct command entry address. To this end, each command word has a prescribed start bit, and long command words have a second start bit for the purpose of distinction.

### CROSS-REFERENCE TO RELATED APPLICATION

This application is a continuation of copending International application PCT/DE02/01442, filed Apr. 18, 2002, which designated the United States, and which was not published in English.

### BACKGROUND OF THE INVENTION

### FIELD OF THE INVENTION

The invention relates to a method for distinguishing a correct command entry address when using command words of different length. If command words of different length are used for the command code of a processor, then it is difficult for the program counter to specify the correct entry address for a command word. If command words of normal length and command words with half the length of the command words of normal length are used, then the address counter may direct the address pointer to the center, that is to say to the second word half of a command word of normal length. This means that the command word cannot be read correctly. Such incorrect entry at the center of a command word has been tolerated to date on the basis of the known prior art, since it is assumed that this results in an incorrect object code. This incorrect object code would be identified and would result in an error message.

However, if entry occurs at such an impermissible address without an error message being generated, there is the risk of misuse or data corruption.

### BRIEF SUMMARY OF THE INVENTION

It is accordingly an object of the invention to provide a method for identifying correct command entry addresses even when command words of different length are used, which overcomes the above-mentioned disadvantages of the prior art methods of this general type.

In particular, an object of the invention is to provide a method for identifying correct command entry addresses, even when command words of different length are used, and for preventing entry at impermissible points.

With the foregoing and other objects in view there is provided, in accordance with the invention, a method for identifying a correct command entry address. The method includes providing each one of a plurality of short command words with a first start bit having a predetermined value. The method also includes providing each one of a plurality of long command words with the first start bit having the predetermined value and with a second start bit having a predetermined value. A signal is output from a checking apparatus if the command entry address is not correct.

Because of the fact that long command words or command words of normal length have at least a first and a second start bit, but half-length command words (short command words) have only one start bit, it is easy to distinguish long command words from half-length command words, which means that it is possible to prevent entry at an impermissible address.

Because of the fact that the first start bit is situated at the beginning of every command word, and the second start bit is situated at the beginning of the second command word half of the long command word, entry at the second command word half results in the entry immediately being identified as incorrect. If the second start bit is the inverse of the first start bit, it is possible to distinguish the first start bit and the second start bit clearly and easily.

Other features which are considered as characteristic for the invention are set forth in the appended claims.

Although the invention is illustrated and described herein as embodied in method for identifying a correct command entry address when using command words of different length, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1A and 1B are diagrams of command words configured in accordance with the invention; and

FIG. 2 is a diagram showing a configuration for carrying out the inventive method.

### DESCRIPTION OF THE PREFERRED EMBODIMENTS

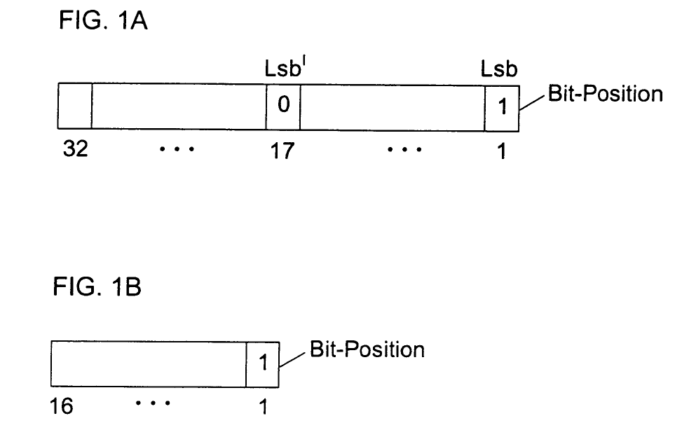

Referring now to the figures of the drawing in detail and first, particularly, to the exemplary embodiment in FIG. 1A thereof, there is shown a command word of normal length (a long command word), i.e. having a length of 32 bits, in symbol form. In this case, the position of the least significant bit, which is identified by “lsb” and which corresponds to the first bit, contains a start bit in the form of a “1” in this case. The 17^{th} bit is the start bit of the second command word half, which is identified by “lsb”. This bit is inverted and thus contains a “0”. FIG. 1B shows a half-length command word (a short command word). The first position of this command word likewise contains a start bit that is identified by “lsb” and contains the value “1”.

At the beginning of every command word, when entering at this address, it is thus a simple matter to check whether the start bit provided, that is to say the “1” in this case, is present. If impermissible entry occurs at the center of the command word, namely at the 17^{th} bit, then the second start bit, namely the inverted “1”, corresponding to a “0”, is identified. This is thus immediately identified as not being a correct entry address, and the second command word half is initially not read at all.

In the manner indicated, it is easy to distinguish long commands from half-length commands. A simple way is used to prevent an impermissible entry at the center of a long command word and reading an unauthorized command, namely the second command word half.

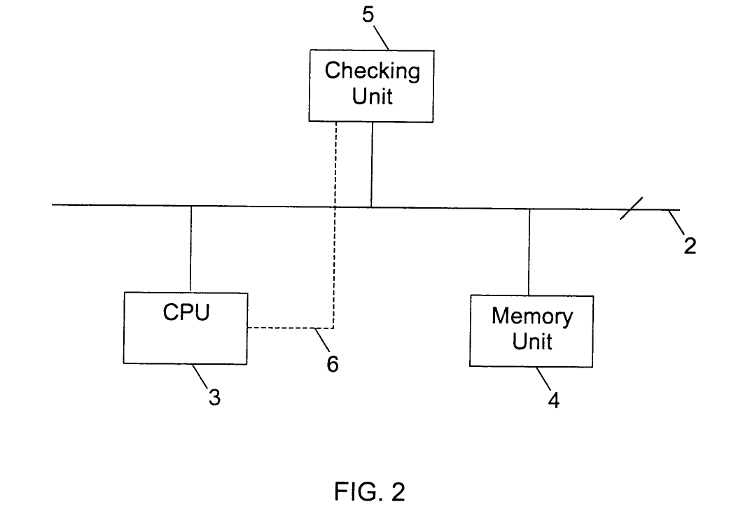

The address is checked as shown in FIG. 2. A CPU 3, a memory unit 4 and a checking unit 5 are connected to one another via a bus 2. If, by way of example, the CPU 3 sends an address to the memory unit 4 via the bus 2, then the checking unit 5 in the example shown checks, on the basis of the previously specified rules, whether the address actually indicates the beginning of a command word. If the beginning of a command word is not involved, this is signaled to the CPU 3 by the checking unit 5. In this case, the signaling can take place via the bus 2 or via an optional additional signal line 6.

The signaling that the address is not correct can result in the CPU 3 being disabled or reset or being put into another desired operating state.

In addition to the example shown, the checking unit 5 can be part of the memory unit 4. It would then check the address register of the memory unit 4, for example, to determine whether the address held in the register is permissible.

We claim:

1. A method for identifying a correct command entry address, the method which comprises:
providing each one of a plurality of short command words with a first start bit having a predetermined value;
providing each one of a plurality of long command words with the first start bit having the predetermined value and with a second start bit having a predetermined value; and
outputting a signal from a checking apparatus if a command entry address is not correct.

2. The method according to claim 1, which further comprises:
outputting a signal from the checking apparatus if an intended entry point is the second start bit.

3. The method according to claim 2, which further comprises:
providing each one of the plurality of long command words with a first command word half having a beginning and a second command word half having a beginning;
configuring the first start bit at the beginning of the first command word half; and
configuring the second start bit at the beginning of the second command word half.

4. The method according to claim 3, which further comprises:
providing the value of the second start bit as an inverse of the value of the first start bit.

5. The method according to claim 2, which further comprises:
providing the value of the second start bit as an inverse of the value of the first start bit.
